(19) United States
(12) Patent Application Publication
(10) Pub. No.: US 2022/0158392 A1
(43) Pub. Date: May 19, 2022

(54) MALE CONNECTOR AND CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Yasuo OMORI, Mie (JP); Yoshihiro MIZUTANI, Mie (JP); Hiroko NISHII, Mie (JP)

(21) Appl. No.: 17/438,365

(22) PCT Filed: Dec. 18, 2019
(86) PCT No.: PCT/JP2019/049613

§ 371 Date: Sep. 10, 2021

(30) Foreign Application Priority Data
Mar. 14, 2019 (JP) 2019-046706

(51) Int. Cl. H01R 13/703

(52) U.S. Cl. CPC H01R 13/7032; H01R 2201/26

(57) ABSTRACT

A male connector 11 provided with a plurality of male terminals 16 to be connected to a plurality of female terminals 14 provided in a female connector 12 includes a receptacle 23 into which the female connector 12 is fit, and a movable member 38 disposed in the receptacle 23 and including an engaging portion 42 to be engaged with the female connector 12. The movable member 38 includes a releasing member 47 for releasing a short circuit by contacting a shorting terminal 28 provided for the plurality of male terminals 16 or the plurality of female terminals 14 to short-circuit the plurality of male terminals 16 or the plurality of female terminals 14.

### TECHNICAL FIELD

The present disclosure relates to a male connector and a connector.

### BACKGROUND

Japanese Patent Laid-Open Publication No. 2011-049043 discloses a connector used, for example, in a circuit for airbag. This connector includes a male connector including male terminals and a female connector including female terminals. The female connector includes a plurality of the female terminals. The female terminals adjacent to each other are electrically short-circuited by a shorting terminal disposed in the female connector.

The male connector includes a fitting recess, into which the female connector is fit. Male tabs of the male terminals and a short-circuit releasing bar are disposed in the fitting recess. The short-circuit releasing bar releases a short-circuit state of the adjacent female terminals by contacting the shorting terminal to deform the shorting terminal. When the female connector is fit into the fitting recess of the male connector, the male terminals and the female terminals are electrically connected and the short-circuit state of the adjacent female terminals is released.

### PRIOR ART DOCUMENT

### Patent Document

Patent Document 1: JP 2011-049043 A

### SUMMARY OF THE INVENTION

### Problems to be Solved

Unlike the above connector, it is considered to short-circuit a plurality of male terminals to each other by a shorting terminal by disposing the shorting terminal in a male connector. In this case, it is considered to provide a releasing member for releasing a short-circuit state of the male terminals by being engaged with the shorting terminal in a female connector.

However, since the female connector does not include such a fitting recess of the male connector, it has been difficult to provide the female connector with a structure for protecting the releasing member.

The present disclosure was completed on the basis of the above situation and aims to provide a male connector capable of releasing a short-circuit state regardless of in which of a male connector and a female connector a shorting terminal is disposed.

### Means to Solve the Problem

The present disclosure is directed to a male connector provided with a plurality of male terminals to be connected to a plurality of female terminals provided in a female connector, the male connector including a receptacle, the female connector being fit into the receptacle, and a movable member disposed in the receptacle, the movable member including an engaging portion to be engaged with the female connector, wherein the movable member includes a releasing member for releasing a short circuit by contacting a shorting terminal provided for the plurality of male terminals or the plurality of female terminals to short-circuit the plurality of male terminals or the plurality of female terminals.

### Effect of the Invention

According to the present disclosure, it is possible to provide a releasing member capable of releasing a short-circuit state in a male connector regardless of in which of a male connector and a female connector a shorting terminal is disposed.

### BRIEF DESCRIPTION OF THE DRAWINGS

FIG. 1 is a perspective view showing a state where a male connector and a female connector are separated in a connector according to a first embodiment.

FIG. 2 is a section showing the state where the male connector and the female connector are separated.

FIG. 3 is a perspective view showing a shorting terminal.

FIG. 4 is a partial enlarged section showing a moving plate.

FIG. 5 is a perspective view showing a releasing member.

FIG. 6 is a partial enlarged section showing a process of connecting the male connector and the female connector.

FIG. 7 is a partial enlarged section showing the process of connecting the male connector and the female connector.

FIG. 8 is a partial enlarged section showing the process of the male connector and the female connector are connected.

FIG. 9 is a partial enlarged section showing a state where the male connector and the female connector are connected.

FIG. 10 is a section showing a state where a male connector and a female connector are separated in a connector according to a second embodiment.

FIG. 11 is a partial enlarged section showing a process of connecting the male connector and the female connector.

FIG. 12 is a partial enlarged section showing the process of connecting the male connector and the female connector.

FIG. 13 is a partial enlarged section showing the process of connecting the male connector and the female connector.

FIG. 14 is a partial enlarged section showing a state where the male connector and the female connector are connected.

### DETAILED DESCRIPTION TO EXECUTE THE INVENTION

[Description of Embodiments of Present Disclosure]

First, embodiments of the present disclosure are listed and described.

(1) The present disclosure is directed to a male connector provided with a plurality of male terminals to be connected to a plurality of female terminals provided in a female connector, the male connector including a receptacle, the female connector being fit into the receptacle, and a movable member disposed in the receptacle, the movable member including an engaging portion to be engaged with the female connector, wherein the movable member includes a releasing member for releasing a short circuit by contacting a shorting terminal provided for the plurality of male terminals or the plurality of female terminals to short-circuit the plurality of male terminals or the plurality of female terminals.

According to the above configuration, the releasing member can be protected by the receptacle. In this way, the releasing member for releasing a short-circuit state can be disposed in the male connector regardless of in which of the male connector and the female connector the shorting terminal is disposed.

(2) The male connector includes the shorting terminal for short-circuiting the plurality of male terminals by contacting the male terminals. Even if the shorting terminal is disposed in the male connector to short-circuit the plurality of male terminals in this way, the releasing member for releasing a short-circuit state of the plurality of male terminals can be disposed in the male connector.

(3) Preferably, the movable member is a moving plate for positioning the male terminals disposed in the receptacle.

According to the above configuration, since one member can double as the movable member and the moving plate, the number of components can be reduced as compared to the case where the releasing member is disposed in a member different from the moving plate.

(4) Preferably, the releasing member is disposed in the movable member movably along a connecting direction of the male connector and the female connector.

According to the above configuration, a contact timing of the releasing member and the shorting terminal can be easily adjusted by adjusting a movement amount of the releasing member.

(5) Preferably, a male-side insertion hole penetrates through a region of the male connector facing the movable member, the releasing member being inserted through the male-side insertion hole, a releasing member insertion hole penetrates through the movable member at a position corresponding to the male-side insertion hole, the releasing member being inserted through the releasing member insertion hole, and a male-side guide recess having an inclined surface is provided in a hole edge part of the male-side insertion hole and a male-side guide projection shaped to correspond to the inclined surface and to be fit into the male-side guide recess is provided on a hole edge part of the releasing member insertion hole.

According to the above configuration, the male-side insertion hole and the releasing member insertion hole are aligned by fitting the male-side guide projection into the male-side guide recess. In this way, the releasing member can smoothly move in the releasing member insertion hole and the male-side insertion hole.

(6) A connector according to the present disclosure includes the male connector of any one of (1) to (5) described above, and a female connector to be connected to the male connector.

According to the above configuration, the connector provided with the male connector having the shorting terminal disposed therein can be obtained.

(7) The female connector includes the shorting terminal for short-circuiting the plurality of female terminals by contacting the plurality of female terminals. Even if the shorting terminal is disposed in the female connector to short-circuit the plurality of female terminals in this way, the releasing member for releasing a short-circuit state of the plurality of female terminals can be disposed in the male connector.

(8) Preferably, a female-side insertion hole penetrates through a region of the female connector facing the movable member, the releasing member being inserted through the female-side insertion hole, a releasing member insertion hole penetrates through the movable member at a position corresponding to the female-side insertion hole, the releasing member being inserted through the releasing member insertion hole, and a female-side guide recess having an inclined surface is provided in a hole edge part of the female-side insertion hole and a female-side guide projection shaped to correspond to the inclined surface and to be fit into the female-side guide recess is provided on a hole edge part of the releasing member insertion hole.

According to the above configuration, the female-side insertion hole and the releasing member insertion hole are aligned by fitting the female-side guide projection into the female-side guide recess. In this way, the releasing member can smoothly move in the releasing member insertion hole and the female-side insertion hole.

[Details of Embodiment of Present Disclosure]

Hereinafter, embodiments of the present disclosure are described. The present invention is not limited to these illustrations and is intended to be represented by claims and include all changes in the scope of claims and in the meaning and scope of equivalents.

### First Embodiment

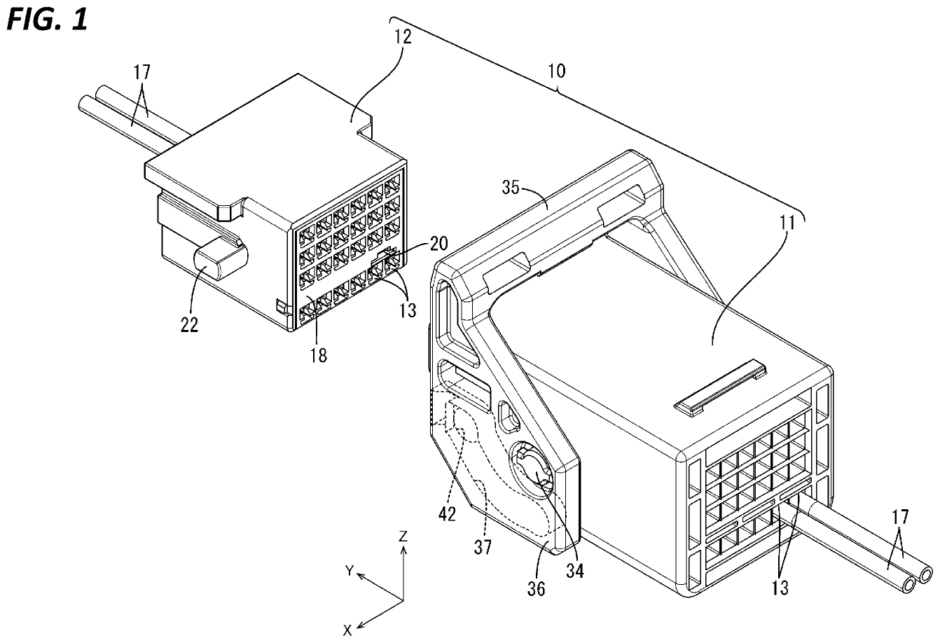

A first embodiment of the present disclosure is described with reference to FIGS. 1 to 9. A connector 10 according to this embodiment is used, for example, as a connector for airbag by being installed in an automotive vehicle. As shown in FIG. 1, the connector 10 includes a male connector 11 and a female connector 12 to be connected to the male connector 11.

In the following description, a Z direction is an upward direction, a Y direction is a forward direction and an X direction is a leftward direction. For a plurality of identical members, some may be denoted by a reference sign and others may not be denoted by the reference sign.

[Female Connector 12]

The female connector 12 is described (see FIG. 1). The female connector 12 is formed by injection-molding a material containing an insulating synthetic resin. The female connector 12 is in the form of a block. The female connector 12 is formed with a plurality of (24 in this embodiment) female cavities 13 arranged in vertical and lateral directions. Female terminals 14 are disposed in the female cavities 13. Note that the female terminals 14 disposed in the female cavities 13 different from those in the lowermost stage are not shown in the drawings attached to this specification.

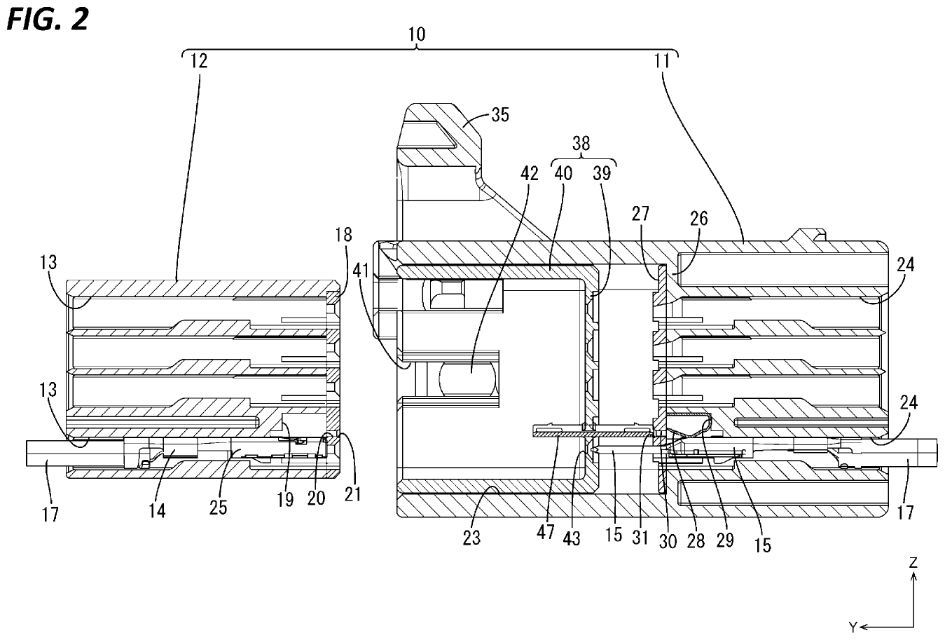

The female terminal 14 includes a connecting tube portion 25 to be electrically connected to a male terminal 16 to be described later by the male terminal 16 being inserted into the connecting tube portion 25 (see FIG. 2). An end part (front end part) of the female terminal 14 opposite to the connecting tube portion 25 is electrically connected to a wire 17.

As shown in FIG. 1, a female stopper 18 somewhat smaller than the outer shape of the female connector 12 is assembled on the rear surface of the female connector 12 to substantially cover the rear surface of the female connector 12. A female-side recess 19 is formed at a position above two female cavities 13 disposed on a right-lower corner part and arranged side by side in the lateral direction in a rear part of the female connector 12. The female stopper 18 is formed with a female-side insertion hole 20 penetrating in a front-rear direction at a position corresponding to the female-side recess 19. A female-side guide recess 21 having an inclined surface widened toward a rear side is formed in a hole edge part of the female-side insertion hole 20.

As shown in FIG. 1, engaged portions 22 projecting laterally outward are respectively formed on both left and right side parts of the female connector 12. The engaged portions 22 have a track shape in a cross-section. The track shape is a shape formed by coupling both end parts of two parallel straight lines by partial arcs.

[Male Connector 11]

Next, the male connector 11 is described (see FIG. 2). The male connector 11 is formed by injection-molding a material containing an insulating synthetic resin. A front-half region of the male connector 11 serves as a receptacle 23 open forward. The inner shape of the receptacle 23 is somewhat larger than the outer shape of the female connector 12. The female connector 12 is fit into the receptacle 23. In this embodiment, the front-rear direction is an example of a connecting direction of the male connector 11 and the female connector 12.

The male connector 11 is formed with a plurality of (24 in this embodiment) male cavities 24 arranged in the vertical and lateral directions. The male terminals 16 are disposed in the male cavities 24. Note that the male terminals 16 disposed in the male cavities 24 different from those in the lowermost stage are not shown in the drawings attached to this specification.

The male terminal 16 includes a male tab 15 extending forward. The male tab 15 is inserted into the connecting tube portion 25 provided in the female terminal 14. An end part (front end part) of the male terminal 16 opposite to the male tab 15 is electrically connected to a wire 17.

The male connector 11 is provided with a rear wall 26 at a position opposite to the receptacle 23 in an opening direction (forward direction) of the receptacle 23. A male stopper 27 for substantially covering the front surface of the rear wall 26 is assembled with the rear wall 26. A male-side recess 29 in which a shorting terminal 28 for short-circuiting two male terminals 16 adjacent in the lateral direction is disposed is formed at a position above two male cavities 24 disposed on a right-lower corner and arranged side by side in the lateral direction on the front surface of the rear wall 26.

The shorting terminal 28 is held in a front stop state in the male-side recess 29 by butting against the male stopper 27 from behind. The male stopper 27 is formed with a male-side insertion hole 30 penetrating in the front-rear direction at a position corresponding to the male-side recess 29. A male-side guide recess 31 having an inclined surface widened toward a front side is formed in a hole edge part of the male-side insertion hole 30.

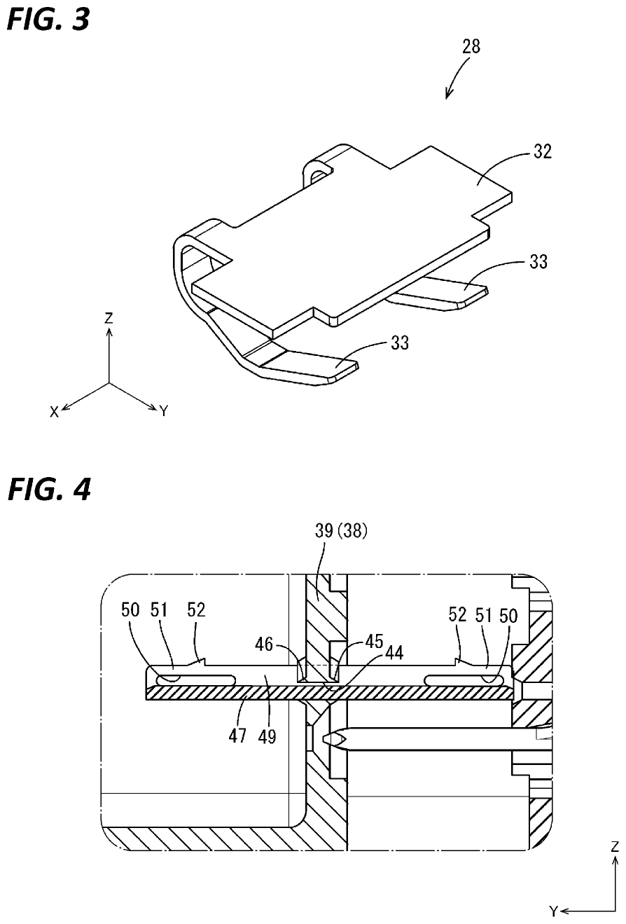

As shown in FIG. 3, the shorting terminal 28 is formed by press-working a metal plate material into a predetermined shape. An arbitrary metal such as copper, copper alloy, aluminum or aluminum alloy can be appropriately selected as a metal constituting the metal plate material. A plating layer of tin, nickel or the like may be formed on the surface of the shorting terminal 28.

The shorting terminal 28 includes a base plate 32 having a substantially rectangular shape extending in the lateral direction when viewed from above, and two contact pieces 33 bent downward from positions near both left and right end parts of the rear end edge of the base plate 32 and folded forward. The contact pieces 33 are bent into a valley shape concave downward when viewed laterally. Lower end parts of the contact pieces 33 resiliently contact the male terminals 16, whereby the male terminals 16 adjacent in the lateral direction are electrically connected via the contact pieces 33. As just described, the shorting terminal 28 is provided to contact the male terminals 16 adjacent in the lateral direction. Tip parts of the contact pieces 33 extend obliquely to a front-upper side. In this way, the contact pieces 33 easily ride on insulating portions 48 to be described later.

As shown in FIG. 1, shaft portions 34 projecting outward in the lateral direction are formed on both left and right side walls of the male connector 11. A lever 35 rotatable about the shaft portions 34 is mounted on the shaft portions 34. The lever 35 includes a pair of side plates 36.

Each side plate 36 is formed with a cam groove 37 in a lateral inner surface. The cam groove 37 is formed to extend in the front-rear direction. A front end part of the cam groove 37 is open on a front edge part of the side plate 36. A rear end part of the cam groove 37 extends up to a position near the shaft portion 34. A distance between the front end part of the cam groove 37 and the shaft portion 34 is longer than a distance between the rear end part of the cam groove 37 and the shaft portion 34.

[Moving Plate 38]

As shown in FIG. 2, the moving plate 38 (an example of a movable member) is formed by injection-molding a material containing an insulating synthetic resin. The moving plate 38 is arranged in the receptacle 23 and positions the respective male terminals 16 in the vertical and lateral directions. The moving plate 38 is movable in the front-rear direction in the receptacle 23. The moving plate 38 includes a plate-like body portion 39 having a substantially rectangular shape and a peripheral wall portion 40 substantially in the form of a rectangular tube extending forward from the peripheral edge of the body portion 39. With the male connector 11 and the female connector 12 connected, the outer peripheral surface of the peripheral wall portion 40 moves in the front-rear direction while sliding in contact with the inner peripheral surface of the receptacle 23.

An introducing groove 41 extending in the front-rear direction and open on the front end edge of the peripheral wall portion 40 is formed near a vertical center in each of both left and right side surfaces of the peripheral wall portion 40. The introducing groove 41 is formed to be able to receive the engaged portion 22. Engaging portions 42 are formed to project outward while extending across the introducing grooves 41 on both left and right side surfaces of the peripheral wall portion 40. The engaging portion 42 is substantially gate-shaped when viewed from front, and the engaged portion 22 is insertable thereinto. The engaging portion 42 is fit into the cam groove 37 of the lever 35 with the engaged portion 22 inserted inside the engaging portion 42.

With the engaged portion 22 inserted inside the engaging portion 42, the engaging portion 42 and the engaged portion 22 are engaged with each other. If a force is applied to one of the engaging portion 42 and the engaged portion 22 to contact the other, the engaging portion 42 and the engaged portion 22 contact each other. Unless a force is applied to one of the engaging portion 42 and the engaged portion 22 to contact the other, the engaging portion 42 and the engaged portion 22 may be in contact with each other or may be separated. By such engagement of the engaging portions 42 and the engaged portions 22, the female connector 12 and the moving plate 38 integrally move in the front-rear direction as the lever 35 is rotated.

Positioning holes 43 into which the male tabs 15 of the respective male terminals 16 are inserted are aligned to penetrate through the body portion 39. A releasing member insertion hole 44 penetrates through the body portion 39 in the front-rear direction at a position corresponding to the male-side insertion hole 30 formed in the male stopper 27 and the female-side insertion hole 20 formed in the female stopper 18.

As shown in FIG. 4, a male-side guide projection 45 projecting rearward is formed on a hole edge part of the releasing member insertion hole 44 on the rear surface of the body portion 39. An inclined surface tapered toward a rear side is formed on the outer surface of the male-side guide projection 45. The outer shape of the male-side guide projection 45 is substantially the same as the inner shape of the male-side guide recess 31 formed in the male stopper 27. Substantially the same means a case where the two shapes are the same and a case where the two shapes are not the same, but can be acknowledged to be substantially the same. The male-side guide projection 45 is fit into the male-side guide recess 31.

A female-side guide projection 46 projecting forward is formed on the hole edge part of the releasing member insertion hole 44 on the front surface of the body portion 39. An inclined surface tapered toward a front side is formed on the outer surface of the female-side guide projection 46. The outer shape of the female-side guide projection 46 is substantially the same as the inner shape of the female-side guide recess 21 formed in the female stopper 18. Substantially the same means a case where the two shapes are the same and a case where the two shapes are not the same, but can be acknowledged to be substantially the same. The female-side guide projection 46 is fit into the female-side guide recess 21.

[Releasing Member 47]

As shown in FIG. 2, a releasing member 47 is inserted into the releasing member insertion hole 44 of the body portion 39 movably in the front-rear direction. The releasing member 47 is formed by injection-molding a material containing an insulating synthetic resin. The releasing member 47 is shaped to be flat in the vertical direction and formed to extend in the front-rear direction.

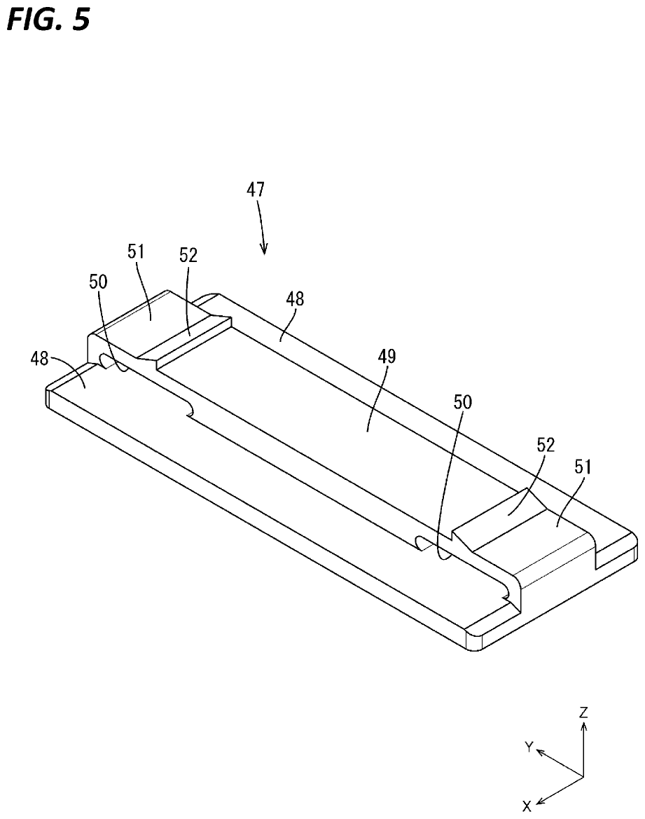

As shown in FIG. 5, both left and right parts of the releasing member 47 serve as the insulating portions 48 configured to contact the contact pieces 33 of the shorting terminal 28. The insulating portions 48 contact the contact pieces 33 to deform the contact pieces 33 in a direction to be separated from the male terminals 16. Further, the insulating portions 48 are inserted between the contact pieces 33 and the male terminals 16, thereby releasing a short-circuit state of the contact pieces 33 and the male terminal 16. Inclined surfaces are formed on front and rear end edges, out of the upper surfaces of the insulating portions 48, so that the contact pieces 33 easily ride on the upper surfaces of the insulating portions 48.

A rail portion 49 projecting upward and extending in the front-rear direction is formed near a lateral center on the upper surface of the releasing member 47. The rail portion 49 slides in contact with the inner surface of the releasing member insertion hole 44 of the body portion 39, whereby the releasing member 47 is guided movably in the front-rear direction. Deflection spaces 50 penetrating in the lateral direction are formed at positions near both end parts in the front-rear direction of the rail portion 49. Out of the rail portion 49, parts above the deflection spaces 50 serve as deflecting portions 51 deflectable and deformable downward. Locking claws 52 projecting upward are formed on the upper surfaces of the deflecting portions 51.

The releasing member 47 is inserted into the releasing member insertion hole 44 of the body portion 39 from front or behind. Then, the locking claw 52 contacts the hole edge part of the releasing member insertion hole 44, whereby the deflecting portion 51 is deflected and deformed downward.

If the releasing member 47 is further inserted into the releasing member insertion hole 44, the deflecting portion 51 is restored. Then, the locking claw 52 contacts the hole edge part of the releasing member insertion hole 44, whereby the releasing member 47 is arranged in the releasing member insertion hole 44 movably in the front-rear direction. A moving distance in the front-rear direction of the releasing member 47 is an interval in the front-rear direction between the two locking claws 52.

[Connection Process of Male Connector 11 and Female Connector 12]

Next, an example of a connection process of the male connector 11 and the female connector 12 is described. The connection process of the male connector 11 and the female connector 12 is not limited to the one described below.

FIG. 2 shows a state where the male connector 11 and the female connector 12 are separated in the front-rear direction. The contact pieces 33 of the shorting terminal 28 disposed in the male connector 11 are in contact with the upper walls of the male terminals 16. In this way, the male terminals 16 adjacent in the lateral direction are electrically connected to each other to be short-circuited.

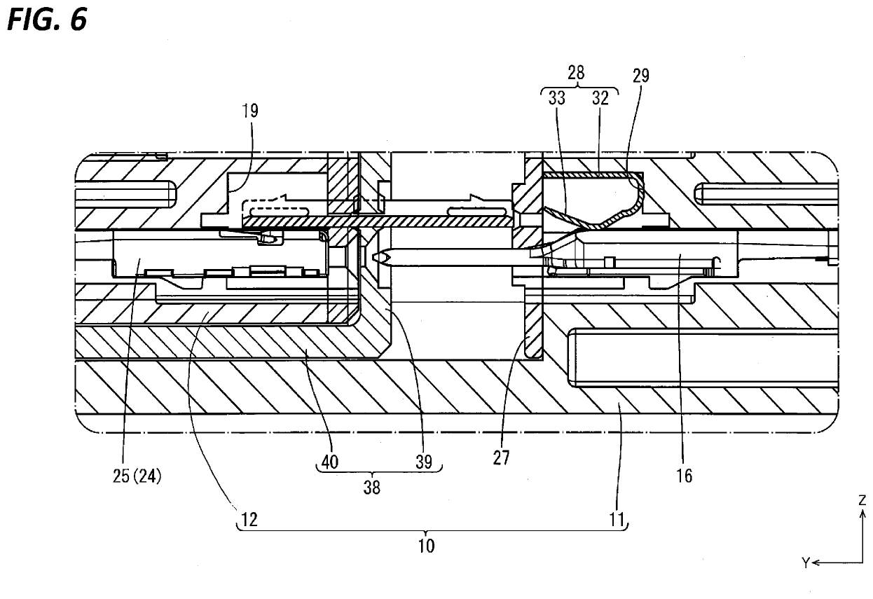

FIG. 6 shows a state where the female connector 12 moves rearward and contacts the moving plate 38. Although not shown in detail, the engaged portions 22 of the female connector 12 are fit inside the engaging portions 42 of the moving plate 38.

The inner wall of the female-side recess 19 of the female connector 12 and the front end part of the releasing member 47 are separated. The male stopper 27 of the male connector 11 and the rear end part of the releasing member 47 are separated. The tips of the male tabs 15 are separated from the female connector 12. The contact pieces 33 of the shorting terminal 28 are in contact with the upper walls of the male terminals 16.

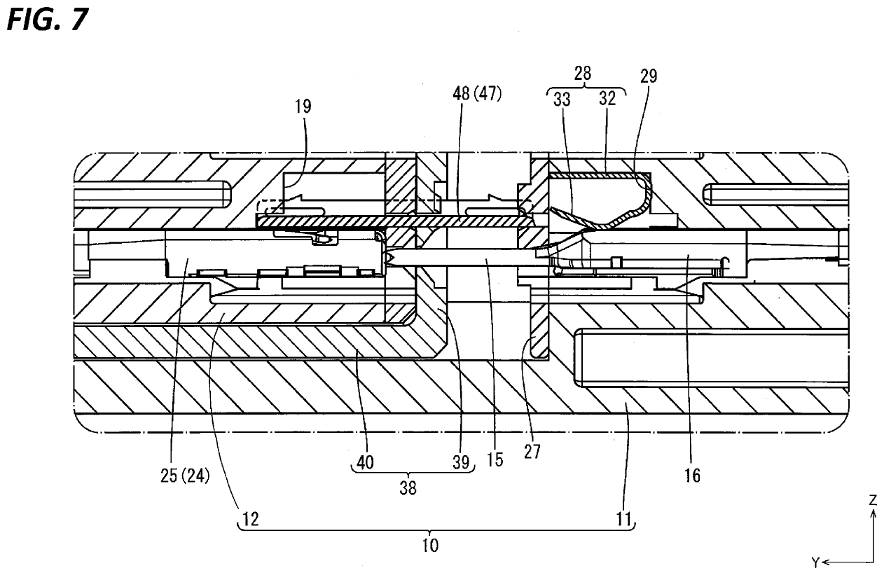

FIG. 7 shows a state where the female connector 12 and the moving plate 38 are somewhat moved rearward by rotating the lever 35 about the shaft portions 34. The front end part of the releasing member 47 is in contact with the inner wall of the female-side recess 19 of the female connector 12. The rear end part of the releasing member 47 is inserted inside the male stopper 27. The rear end part of the releasing member 47 is separated from the contact pieces 33 of the shorting terminal 28. The contact pieces 33 of the shorting terminal 28 are in contact with the upper walls of the male terminals 16. The tips of the male tabs 15 provided in the male terminals 16 are slightly inserted inside the connecting tube portions 25 of the female terminals 14.

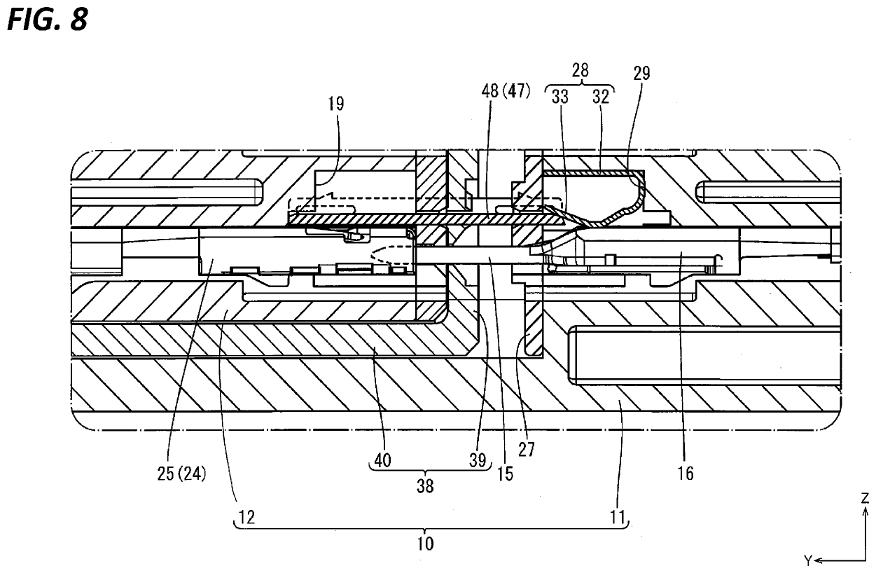

FIG. 8 shows a state where the female connector 12 and the moving plate 38 are further moved rearward by further rotating the lever 35. The front end part of the releasing member 47 is in contact with the inner wall of the female-side recess 19 of the female connector 12. In this way, the releasing member 47 moves rearward by being pushed by the female connector 12 as the female connector 12 and the moving plate 38 move rearward. An end part of the releasing member 47 on the side of the female connector 12 penetrates through the male stopper 27 and contacts the contact pieces 33 of the shorting terminal 28 from front. The male tabs 15 are inserted inside the connecting tube portions 25. In this way, the male terminals 16 and the female terminals 14 are electrically connected. The contact pieces 33 of the shorting terminal 28 are in contact with the upper walls of the male terminals 16 and the adjacent male terminals 16 are still electrically short-circuit to each other.

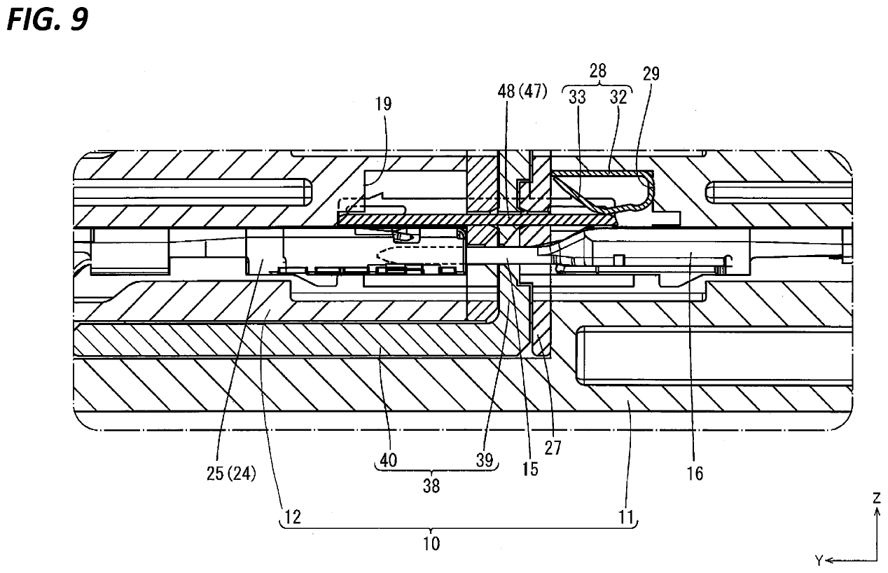

FIG. 9 shows a state where the male connector 11 and the female connector 12 are completely connected by further rotating the lever 35. The rear end part of the releasing member 47 contacts the contact pieces 33 of the shorting terminal 28 to deflect and deform the contact pieces 33 upward. In this way, the contact pieces 33 are separated from the male terminals 16. As a result, the male terminals 16 adjacent in the lateral direction are no longer electrically connected to each other.

Further, the insulating portions 48 of the releasing member 47 are interposed between the contact pieces 33 and the male terminals 16. In this way, the contact pieces 33 and the male terminals 16 are electrically insulated. As a result, the male terminals 16 adjacent in the lateral direction are electrically insulated from each other.

As described above, since the male terminals 16 and the female terminals 14 are electrically connected by inserting the male tabs 15 into the connecting tube portions 25, the male terminals 16 and the female terminals 14 are electrically connected with the male terminals 16 adjacent in the lateral direction electrically insulated from each other.

[Functions and Effects of Embodiment]

Next, functions and effects of this embodiment are described. The male connector 11 according to this embodiment includes the plurality of male terminals 16 to be connected to the plurality of female terminals 14 provided in the female connector 12, the receptacle 23 into which the female connector 12 is fit, and the moving plate 38 disposed in the receptacle 23 and having the engaging portions 42 to be engaged with the female connector 12, and the moving plate 38 includes the releasing member 47 for releasing a short circuit by contacting the shorting terminal 28 provided for the plurality of male terminals 16 to short-circuit the plurality of male terminals.

According to the above configuration, the releasing member 47 can be protected by the receptacle 23. In this way, the releasing member 47 for releasing a short-circuit state can be disposed in the male connector 11 regardless of in which the male connector 11 and the female connector 12 the shorting terminal 28 is disposed.

According to this embodiment, the male connector 11 includes the shorting terminal 28 for short-circuiting the plurality of male terminals 16 by contacting the plurality of male terminals 16. Even if the shorting terminal 28 is disposed in the male connector 11 to short-circuit the plurality of male terminals 16 in this way, the releasing member 47 for releasing a short-circuit state of the plurality of male terminals 16 can be disposed in the male connector 11.

According to this embodiment, the releasing member 47 is disposed in the moving plate 38 for positioning the male terminals 16 disposed in the receptacle 23. In this way, the number of components can be reduced as compared to the case where the releasing member 47 is disposed in a member different from the moving plate 38.

According to this embodiment, the releasing member 47 is disposed in the moving plate 38 movably along the connecting direction of the male connector 11 and the female connector 12.

According to the above configuration, a contact timing of the releasing member 47 and the shorting terminal 28 can be easily adjusted by adjusting a movement amount of the releasing member 47. [0068]

According to this embodiment, the male-side insertion hole 30, into which the releasing member 47 is inserted, penetrates through a region of the male connector 11 facing the moving plate 38, the releasing member insertion hole 44, into which the releasing member 47 is inserted, penetrates through the moving plate 38 at the position corresponding to the male-side insertion hole 30, the male-side guide recess 31 having the inclined surface is provided in the hole edge part of the male-side insertion hole 30, and the male-side guide projection 45 shaped to correspond to the inclined surface and to be fit into the male-side guide recess 31 is provided on the hole edge part of the releasing member insertion hole 44.

According to the above configuration, the male-side insertion hole 30 and the releasing member insertion hole 44 are aligned by fitting the male-side guide projection 45 into the male-side guide recess 31. In this way, the releasing member 47 can smoothly move in the releasing member insertion hole 44 and the male-side insertion hole 30.

The connector 10 according to this embodiment includes the male connector 11 and the female connector 12 to be connected to the male connector 11. In this way, the connector 10 provided with the male connector 11 having the shorting terminal 28 disposed therein can be obtained.

According to this embodiment, the female-side insertion hole 20, into which the releasing member 47 is inserted, penetrates through a region of the female connector 12 facing the moving plate 38, the releasing member insertion hole 44, into which the releasing member 47 is inserted, penetrates through the moving plate 38 at the position corresponding to the female-side insertion hole 20, the female-side guide recess 21 having the inclined surface is provided in the hole edge part of the female-side insertion hole 20, and the female-side guide projection 46 shaped to correspond to the inclined surface and to be fit into the female-side guide recess 21 is provided on the hole edge part of the releasing member insertion hole 44.

According to the above configuration, the female-side insertion hole 20 and the releasing member insertion hole 44 are aligned by fitting the female-side guide projection 46 into the female-side guide recess 21. In this way, the releasing member 47 can smoothly move in the releasing member insertion hole 44 and the female-side insertion hole 20.

### Second Embodiment

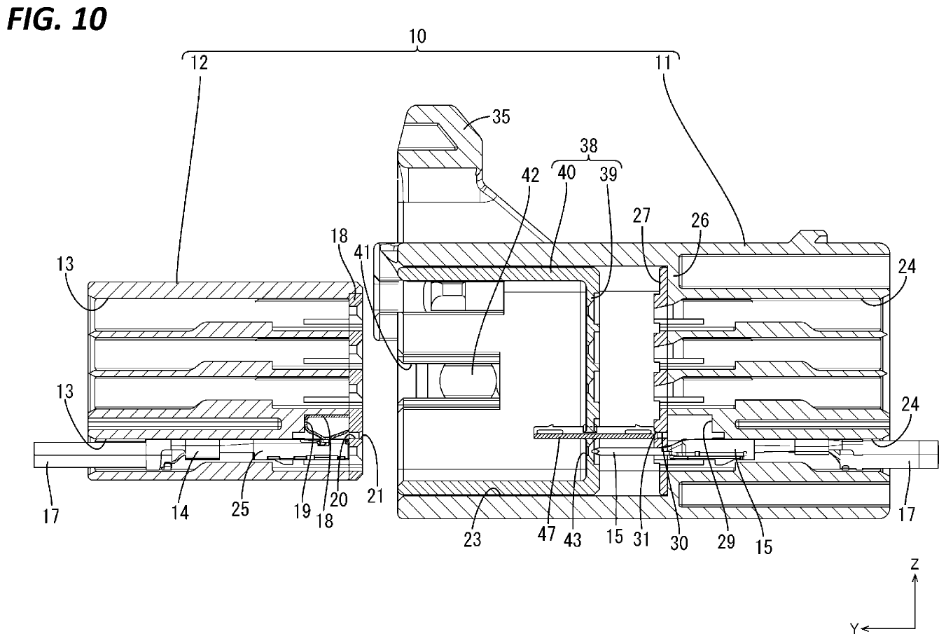

Next, a second embodiment of the present disclosure is described with reference to FIGS. 10 to 14. As shown in FIG. 10, a shorting terminal 28 is not accommodated inside a male-side recess 29 provided in a male connector 11 according to this embodiment. The shorting terminal 28 is accommodated inside a female-side recess 19 provided in a female connector 12 according to this embodiment. The shorting terminal 28 according to this embodiment is accommodated into the male-side recess 29 with contact pieces 33 facing rearward. Adjacent female terminals 14 are electrically short-circuited to each other by the contact of the shorting terminal 28 with the female terminals 14 adjacent in a lateral direction. As just described, the shorting terminal 28 is provided to contact the female terminals 14 adjacent in the lateral direction. The shorting terminal 28 butts against a female stopper 18 from behind, thereby being held in a front stop state in the female-side recess 19.

Since the other configuration is substantially the same as in the first embodiment, the same components are denoted by the same reference signs and repeated description is omitted.

[Connection Process of Male Connector 11 and Female Connector 12]

Next, an example of a connection process of the male connector 11 and the female connector 12 is described. The connection process of the male connector 11 and the female connector 12 is not limited to the one described below.

FIG. 10 shows a state where the male connector 11 and the female connector 12 are separated in a front-rear direction. The contact pieces 33 of the shorting terminal 28 disposed in the female connector 12 are in contact with the upper walls of connecting tube portions 25 formed in the female terminals 14. In this way, the female terminals 14 adjacent in the lateral direction are electrically connected to each other to be short-circuited.

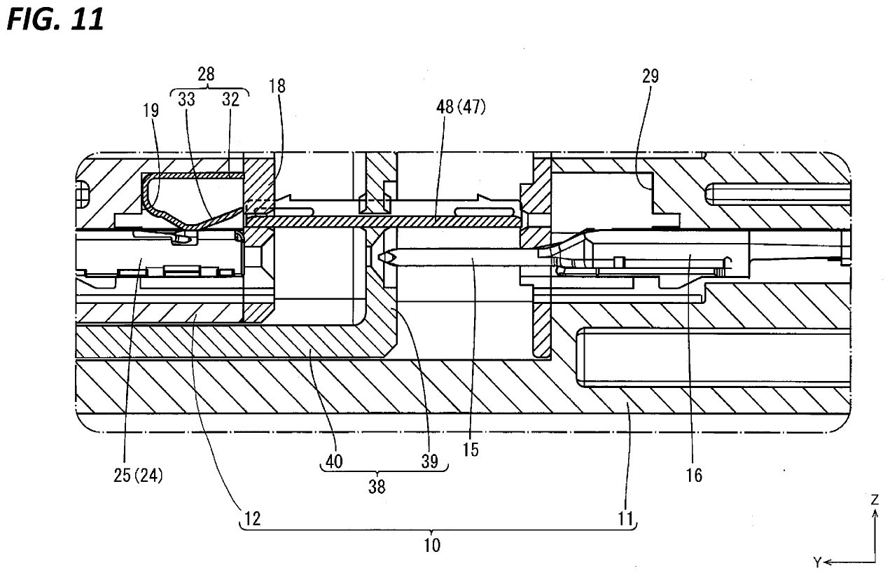

FIG. 11 shows a state where the female connector 12 is moved somewhat rearward. The female connector 12 and a moving plate 38 are separated. A front end part of a releasing member 47 is inserted in the female stopper 18. The front end part of the releasing member 47 is separated from the contact pieces 33 of the shorting terminal 28. The tips of male tabs 15 are separated from the female connector 12. The contact pieces 33 of the shorting terminal 28 are in contact with the upper walls of the female terminals 14.

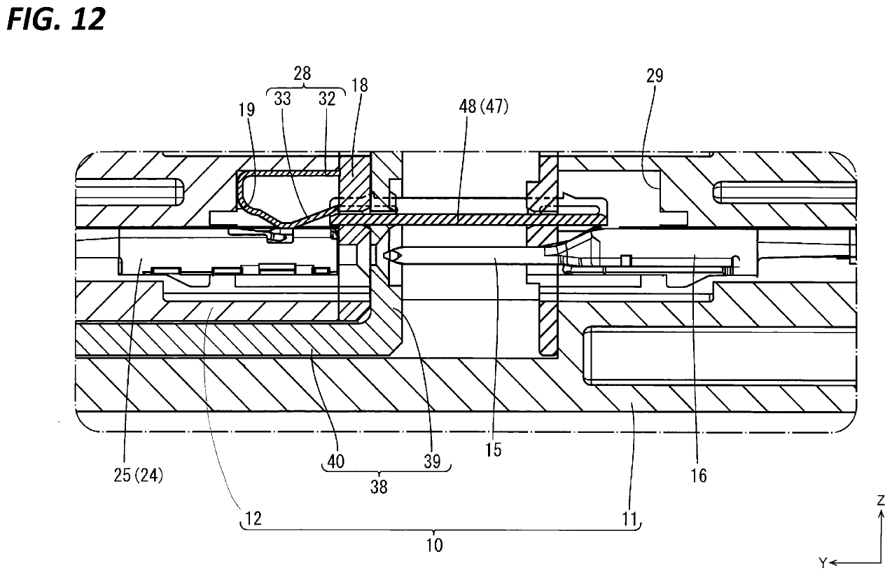

FIG. 12 shows a state where the female connector 12 is moved rearward and in contact with the moving plate 38. Although not shown in detail, engaged portions 22 of the female connector 12 are fit inside engaging portions 42 of the moving plate 38. The front end part of the releasing member 47 passes through the female stopper 18 and contacts the contact pieces 33 of the shorting terminal 28. In this way, the releasing member 47 is pushed by the contact pieces 33 to move rearward as the male connector 11 and the moving plate 38 move rearward. The front end part of the releasing member 47 is inserted inside a male stopper 27. The front end part of the releasing member 47 is separated from the inner wall of the male-side recess 29. The contact pieces 33 of the shorting terminal 28 are in contact with the upper walls of the male terminals 15. The male tabs 15 provided in the male terminals 16 are separated from the connecting tube portions 25 of the female terminals 14.

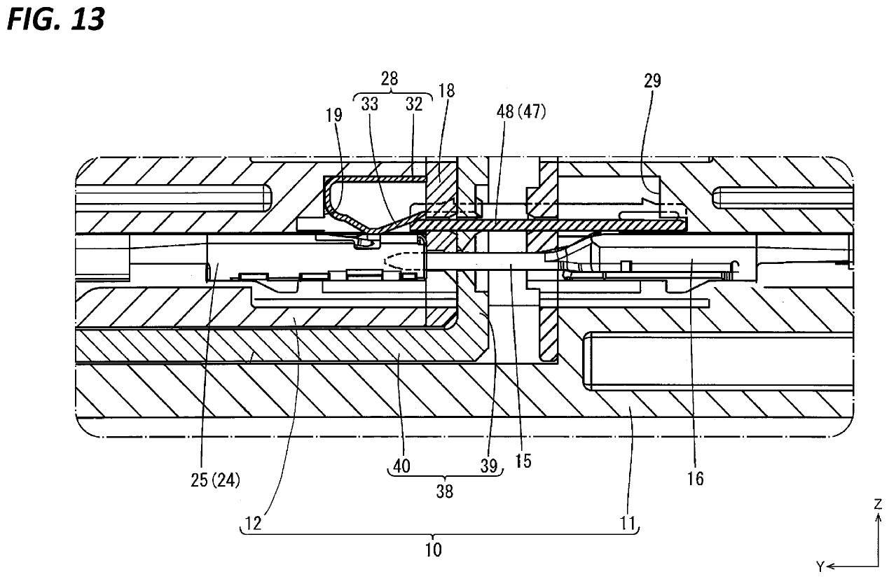

FIG. 13 shows a state where the female connector 12 and the moving plate 38 are further moved rearward by further rotating a lever 35. The front end part of the releasing member 47 passes through the female stopper 18 and contacts the contact pieces 33 of the shorting terminal 28. The rear end part of the releasing member 47 is in contact with the inner wall of the male-side recess 29 of the male connector 11. In this way, the releasing member 47 does not move any further rearward even if the female connector 12 and the moving plate 38 further move rearward. The male tabs 15 are inserted inside the connecting tube portions 25. In this way, the male terminals 16 and the female terminals 14 are electrically connected. The contact pieces 33 of the shorting terminal 28 are in contact with the upper walls of the female terminals 14 and the adjacent female terminals 14 are still electrically short-circuit to each other.

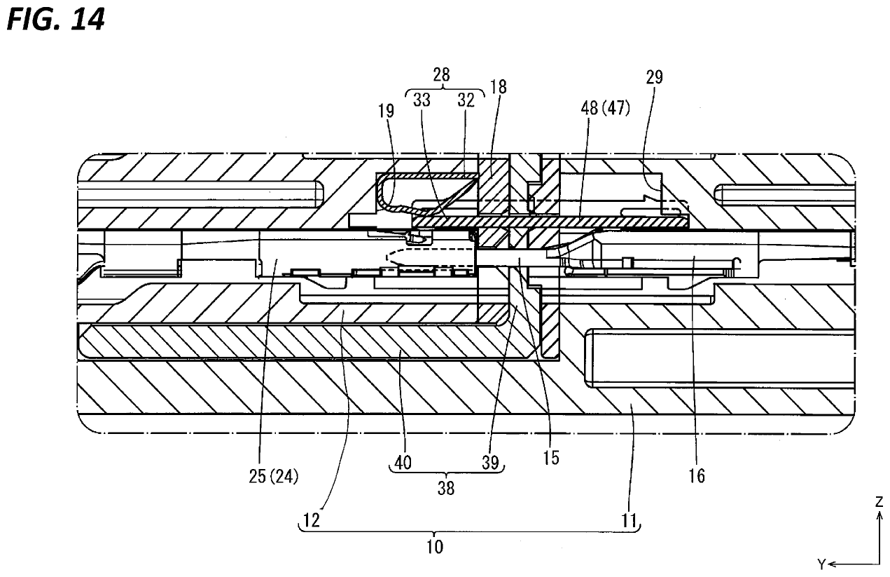

FIG. 14 shows a state where the male connector 11 and the female connector 12 are completely connected by further rotating the lever 35. Since the rear end part of the releasing member 47 is in contact with the inner wall of the male-side recess 29 of the male connector 11, the releasing member 47 does not move rearward. When the female connector 12 and the moving plate 38 move rearward by rotating the lever 35, the front end part of the releasing member 47 contacts the contact pieces 33 of the shorting terminal 28 disposed in the female connector 12 to deflect and deform the contact pieces 33 upward. In this way, the contact pieces 33 are separated from the female terminals 14. As a result, the female terminals 14 adjacent in the lateral direction are no longer electrically connected to each other.

Further, insulating portions 48 of the releasing member 47 are interposed between the contact pieces 33 and the female terminals 14. In this way, the contact pieces 33 and the female terminals 14 are electrically insulated. As a result, the female terminals 14 adjacent in the lateral direction are electrically insulated from each other.

As described above, since the male terminals 16 and the female terminals 14 are electrically connected by inserting the male tabs 15 into the connecting tube portions 25, the male terminals 16 and the female terminals 14 are electrically connected with the female terminals 14 adjacent in the lateral direction electrically insulated from each other.

[Functions and Effects of Embodiment]

The female connector 12 according to this embodiment includes the shorting terminal 28 for short-circuiting the plurality of female terminals 14 by contacting the plurality of female terminals 14. In this way, the releasing member 47 for releasing a short-circuit state of the plurality of female terminals 14 can be disposed in the male connector 11 even if the shorting terminal 28 is disposed in the female connector 12 to short-circuit the plurality of female terminals 14.

Further, according to this embodiment, the rear end part of the releasing member 47 contacts the inner wall of the male-side recess 29 formed in the male connector 11, whereby a rearward movement thereof is restricted. In this way, a contact timing of the front end part of the releasing member 47 and the contact pieces 33 can be easily adjusted by adjusting the shape of the male-side recess 29.

### Other Embodiments

The present disclosure is not limited to the above described and illustrated embodiments. For example, the following embodiments are also included in the technical scope of the technique disclosed in this specification.

(1) The movable member in which the releasing member 47 is disposed may be a member different from the moving plate 38.

(2) The releasing member 47 may be fixed to the moving plate 38. The releasing member 47 may be integrally formed to the moving plate 38.

(3) The body portion 39 of the moving plate 38 may serve as an engaging portion, and this body portion 39 may contact and engage the female connector 12.

(4) The male connector 11 may not include the male-side guide recess 31, and the moving plate 38 may not include the male-side guide projection 45.

(5) The female connector 12 may not include the female-side guide recess 21, and the moving plate 38 may not include the female-side guide projection 46.

(6) The shorting terminal 28 may be disposed in the male-side recess 29 of the male connector 11, and the shorting terminal 28 may also be disposed in the female-side recess 19 of the female connector 12.

(7) A plurality of shorting terminals 28 may be disposed in one male connector 11. A plurality of shorting terminals 28 may be disposed in one female connector 12.

(8) Although the male connector 11 and the female connector 12 are connected to the wires 17, there is no limitation to this. The male connector 11 and the female connector 12 may be connected to a circuit board, a device or an arbitrary member.

### LIST OF REFERENCE NUMERALS

10: connector

11: male connector

12: female connector

13: female cavity

14: female terminal

15: male tab

16: male terminal

17: wire

18: female stopper

19: female-side recess

20: female-side insertion hole

21: female-side guide recess

22: engaged portion

23: receptacle

24: male cavity

25: connecting tube portion

26: rear wall

27: male stopper

28: shorting terminal

29: male-side recess

30: male-side insertion hole

31: male-side guide recess

32: base plate

33: contact piece

34: shaft portion

35: lever

36: side plate

37: cam groove

38: moving plate

39: body portion

40: peripheral wall portion

41: introducing groove

42: engaging portion

43: positioning hole

44: releasing member insertion hole

45: male-side guide projection

46: female-side guide projection

47: releasing member

48: insulating portion

49: rail portion

50: deflection space

51: deflecting portion

52: locking claw

1. A male connector provided with a plurality of male terminals to be connected to a plurality of female terminals provided in a female connector, comprising:
a receptacle, the female connector being fit into the receptacle; and
a movable member disposed in the receptacle, the movable member including an engaging portion to be engaged with the female connector,
wherein the movable member includes a releasing member for releasing a short circuit by contacting a shorting terminal provided for the plurality of male terminals or the plurality of female terminals to short-circuit the plurality of male terminals or the plurality of female terminals.

2. The male connector of claim 1, comprising the shorting terminal for short-circuiting the plurality of male terminals by contacting the male terminals.

3. The male connector of claim 1, wherein the movable member is a moving plate for positioning the male terminals disposed in the receptacle.

4. The male connector of claim 1, wherein the releasing member is disposed in the movable member movably along a connecting direction of the male connector and the female connector.

5. The male connector of claim 1, wherein:
a male-side insertion hole penetrates through a region of the male connector facing the movable member, the releasing member being inserted through the male-side insertion hole,
a releasing member insertion hole penetrates through the movable member at a position corresponding to the male-side insertion hole, the releasing member being inserted through the releasing member insertion hole, and
a male-side guide recess having an inclined surface is provided in a hole edge part of the male-side insertion hole and a male-side guide projection shaped to correspond to the inclined surface and to be fit into the male-side guide recess is provided on a hole edge part of the releasing member insertion hole.

6. A connector, comprising:
the male connector of claim 1; and
a female connector to be connected to the male connector.

7. The connector of claim 6, wherein the female connector includes the shorting terminal for short-circuiting the plurality of female terminals by contacting the plurality of female terminals.

8. The connector of claim 6, wherein:
a female-side insertion hole penetrates through a region of the female connector facing the movable member, the releasing member being inserted through the female-side insertion hole,
a releasing member insertion hole penetrates through the movable member at a position corresponding to the female-side insertion hole, the releasing member being inserted through the releasing member insertion hole, and
a female-side guide recess having an inclined surface is provided in a hole edge part of the female-side insertion hole and a female-side guide projection shaped to correspond to the inclined surface and to be fit into the female-side guide recess is provided on a hole edge part of the releasing member insertion hole.
